(19) United States
(12) Patent Application Publication
(10) Pub. No.: US 2005/0230964 A1
(43) Pub. Date: Oct. 20, 2005

(54) Label

(76) Inventor: Peter Seidl, Munchen (DE)

Correspondence Address: WILLIAM COLLARD;COLLARD & ROE, P.C., 1077 NORTHERN BOULEVARD, ROSLYN, NY, 11576, US

(21) Appl. No.: 11/109,080

(22) Filed: Apr. 19, 2005

(30) Foreign Application Priority Data
Apr. 19, 2004 (DE) 102 004018833.5

(51) Int. Cl. B42D 15/00

(52) U.S. Cl. 283/81

(57) ABSTRACT

A label having a base layer (1), on which at least one product information sheet (2a, 2b) is positioned, and having an upper label layer (3), which is positioned on the base layer (1) and is shaped in such a way that it forms at least one hanger loop (4) and a cover sheet (5) covering the at least one product information sheet (2a, 2b). In the novel label, according to the present invention, the cover sheet and the hanger loop are manufactured from one single material layer, specifically the upper label layer. The label is therefore distinguished in relation to the typical achievements of the object by efficient and material-saving manufacturing. As a further advantage, it is to be noted that the individual components, such as hanger loop and cover sheet, do not mutually influence one another during use.

The present invention relates to a label having at least one product information sheet and at least one hanger loop.

Labels of this type, which are usually intended for hanging containers for medical infusions, are known from U.S. Pat. No. 5,967,560 and U.S. Pat. No. 5,782,495. The label known from U.S. Pat. No. 5,967,560 has a hanger loop which runs in the end region of the label and is folded outward for use. Product information sheets in the form of a booklet and removable self-adhesive voucher sections are positioned in the central region of the label (FIG. 15 of U.S. Pat. No. 5,967,560). The construction of the known label requires the booklet and the voucher sections to be attached after the hanger loop is attached. An additional material layer is necessary for the cover sheet for covering the booklet and for producing the voucher sections. Manufacturing the known label is therefore complex.

In the label known from U.S. Pat. No. 5,782,495, the hanger loop is connected in one piece to the label on a first side of the label. Before use, the hanger loop is folded over on the label. A cover sheet for a booklet is stuck on to a second side of the label running perpendicularly to the first side, which is folded over on the label before use, so that it lies over the folded-over hanger loop. An additional material layer for the cover sheet of the booklet is also necessary in this label. To use the label, the booklet must first be folded outward, before the user may fold the hanger loop outward. For the user, it is not recognizable without something further that the label is equipped with a hanger loop before the booklet is folded out. In emergency situations, valuable time may thus be lost due to finding and unfolding the booklet and the hanger loop.

On the basis of this related art, the present invention is based on the object of providing a label having at least one product information sheet and at least one hanger loop, which is cost-effective to manufacture and is distinguished by simple handling. In particular, the user is to have the ability to fold out the product information sheet and the hanger loop in any arbitrary sequence as needed.

To achieve this object, a label is provided according to the present invention having a base layer, on which at least one product information sheet is positioned, and having an upper label layer, which is positioned on the base layer and shaped in such a way that it forms at least one hanger loop and one cover sheet which covers the at least one product information sheet.

In this construction, according to the present invention, the cover sheet and the hanger loop are manufactured from one single material layer, specifically the upper label layer. The label is therefore distinguished in relation to the typical achievements of the object by efficient and material-saving manufacture. As a surprising and in no way foreseeable advantage it is to be noted that in the arrangement cited, the individual components, such as hanger loop and cover sheet, do not mutually influence one another during use. Rather, the user is free to only expose the product information sheet after folding out the cover sheet or to fold out the hanger loop in order to hang the container provided with the label on a hook, for example. The usage is intuitive and understandable without time-consuming study of instructions.

According to an especially advantageous refinement of the present invention, the upper label layer is designed in such a way that it forms at least one removable self-adhesive voucher section. For this purpose, the upper label layer has at least one self-adhesive region, which is provided with stamps or perforations that delimit the at least one voucher section, which preferably has a non-adhesive grasp tab. The base layer is advantageously provided with an adhesive-repellent layer, such as a silicone layer, on the corresponding location of the base layer on which the voucher section rests, in order to make removing the self-adhesive voucher section easier. Removing the at least one voucher sections is also not influenced in any way by the other functions, such as folding out the hanger loop or exposing the product information sheet. Rather, in contrast to typical labels, all three functions cited are independent of one another.

In addition, the upper label layer is exploited optimally, which results in a significant savings in manufacturing outlay in comparison to the related art.

According to a further advantageous embodiment of the present invention, the cover sheet has a self-adhesive part, via which it is permanently connected to the base layer. This part represents a kind of spine of the product information sheet or the booklet. Furthermore, the cover sheet has a non-adhesive part, which covers the at least one product information sheet or the booklet. Finally, the cover sheet has a further self-adhesive part. This further self-adhesive part lies on an adhesive-repellent layer of the base layer. It ensures that the booklet or the product information sheet is securely closed. Since it adheres removably on the corresponding location because of the adhesive-repellent property of the base layer, the closure may be opened easily, particularly if it has a non-adhesive grasp tab, on which it may be grasped easily.

According to a further advantageous embodiment of the present invention, the hanger loop is formed by a strip separated from the upper label layer, which is connected on at least two root regions to the upper label layer and in this way forms a closed hanger loop.

According to a further advantageous embodiment of the present invention, the upper label layer has a first and a second long side and two transverse sides and the two root regions are positioned on the first long side. The hanger loop has a first branch,. which runs starting from the first root region in the direction toward the second root region. Before reaching the second root region, it passes into a bend. An adjoining second branch runs from the bend in the direction toward the second long side and has a turn in the region of the second long side. A third branch runs from the turn to the second root region of the first long side. Through this arrangement of the hanger loop, a coherent space is provided outside the closed hanger loop, which may be used in manifold ways.

According to a further advantageous embodiment of the present invention, the cover sheet for the booklet or the product information sheet is positioned outside the closed hanger loop.

According to a further advantageous embodiment of the present invention, the cover sheet is positioned adjoining the first branch and the second branch of the hanger loop.

The space between the second and third branches inside the closed hanger loop is used for positioning at least one detachable voucher section according to a further advantageous embodiment.

Further advantageous embodiments may be inferred from the subclaims.

The present invention will be described in greater detail in the following on the basis of an exemplary embodiment schematically illustrated in the drawing.

FIG. 1 shows the label according to the present invention in a top view;

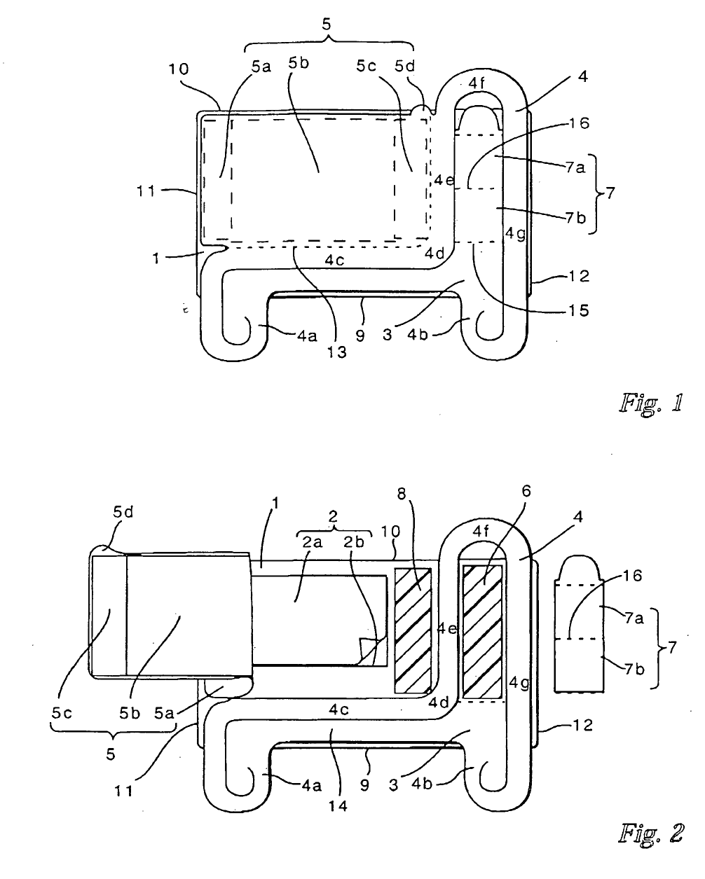

FIG. 2 shows a label from FIG. 1, with an information booklet being exposed and a self-adhesive voucher section being removed, however; and

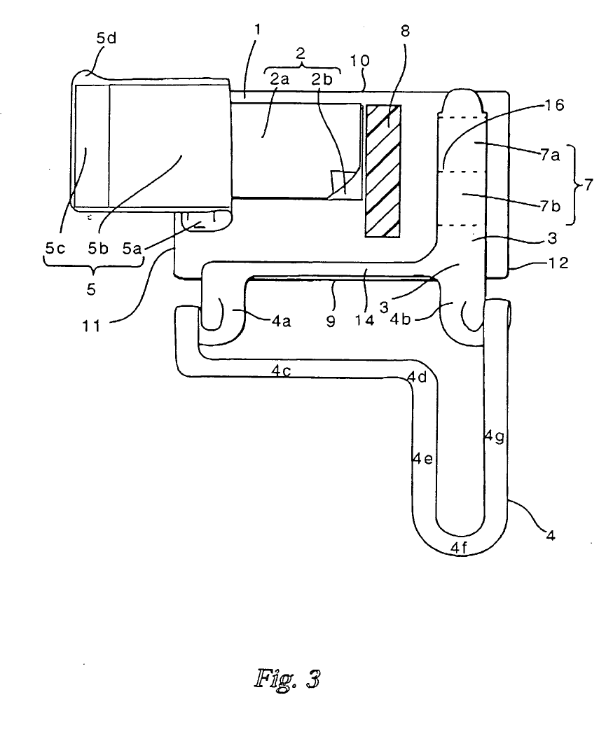

FIG. 3 shows the label from FIG. 1, the hanger loop being folded out and the information booklet being exposed.

The label shown in FIG. 1 has a base layer 1, which has a rectangular outline, and an upper label layer 3 which largely covers the base layer 1. The base layer 1 is a film which is coated over the entire surface of its side lying on the bottom in the illustration in FIG. 1 with an adhesive (not shown in the drawing), using which it may be permanently attached in use to a medication container (not shown), for example. The second side of the base layer 1 (i.e., the side of the base layer 1 lying on top in the drawing) has two adhesive-repellent layers 6 and 5 (shown in FIG. 2), whose significance will be explained below in detail on the basis of FIG. 2. The base layer 1 may additionally be printed with arbitrary imprints of a decorative or informative type.

The upper label layer 3 adheres to at least some locations of the side of the base layer 1 on top in FIG. 1. As may be seen in FIG. 1, the upper label layer 3 projects beyond the contour of the base layer 1 at some locations. The upper label layer 3 is a preferably transparent film, which is coated on its side facing toward the base layer 1 with an adhesive, using which it adheres at least partially to the base layer 1. As will be explained in detail below, however, it is necessary for the upper label layer 3 to adhere only slightly or not at all to the base layer 1 at some locations. At the locations at which the adhesion is to be prevented or weakened, the layer made of adhesive is printed with an adhesive killer. This is a lacquer which is applied to the adhesive layer, for example. Alternatively to this, it is also possible to print the layer made of adhesive on the bottom of the upper label layer 3 only partially, where adhesion is desired. A second alternative method of making the upper label layer 3 only partially adhesive is to cover a complete coating with adhesive locally using a thin film, in order to thus cancel out the adhesive effect of the adhesive at some locations.

As may be seen in FIG. 1, the upper label layer 3 has a rectangular region which is used as the cover sheet 5 for covering a product information sheet or booklet—as will be explained in greater detail below. The cover sheet 5 is connected to the remaining upper label layer 3 using an easily separable perforation stamp 13, and is easily detachable therefrom by separating the perforation stamp 13. In a first part 5a, the cover sheet 5 is self-adhesive. In a middle part 5b of the cover sheet, it is non-adhesive, i.e., the layer made of adhesive on the bottom of the cover sheet 5 is printed with an adhesive killer there. In a third part 5c, the cover sheet 5 is again self-adhesive. The cover sheet 5 has a grasp tab 5d projecting past the contour of the base layer 1, which is non-adhesive on its bottom. The cover sheet 5 may be grasped and pulled off on this projecting, non-adhesive grasp tab. The cover sheet 5 is solidly and permanently connected to the base layer 1 in the region of the adhesive part 5a. The adhesive-repellent layer 8 already described above, which allows easy detachment of the part 5c from the base layer 1, is located in the region 5c of the cover sheet, which is also self-adhesive.

A hanger loop 4 forms a further part of the upper label layer 3. The hanger loop 4 is a narrow strip separated from the remaining upper label layer 3 through stamping or perforation. It comprises a first branch 4c, which runs starting from a first root region 4a approximately parallel to the long side 9 of the label. An approximately perpendicular bend 4d is then provided, after which the strip runs approximately parallel to the transverse side 12. This is followed in proximity to the second long side 10 by a turn 4f. After this, the strip runs along the transverse side 12 to the second root region 4b. The two root regions 4a and 4b are connected to one another via a web 14, so that a closed loop is formed.

The two root regions 4a and 4b—insofar as they rest on the base layer 1—and the web 14 of the upper label layer 3 connecting the two root regions 4a and 4b are permanently and connected to the base layer 1 in a load-bearing way by the adhesive layer on the bottom of the upper label layer 3. The remaining parts of the hanger loop 4, i.e., particularly the branches 4c, 4e, and 4g and the bend 4d and the turn 4f are non-adhesive or only weakly adhesive, so that the hanger loop 4 may be lifted easily off of the base layer 1. For this purpose, it may be gripped very comfortably on the turn 4f projecting past the base layer 1.

A further part of the upper label layer 3 is used to implement a removable self-adhesive voucher section 7. The voucher section 7 is delimited on two diametrically opposing sides by the stamp line of the branches 4e and 4g of the hanger loop 4. The voucher section 7 is separable from the remaining upper label layer 3 by a first perforation 15. The voucher section 7 may be divided into two partial sections 7a and 7b by a further perforation 16. The voucher section 7 is self-adhesive on its side facing toward the base layer 1, so that it may be stuck into a documentation document after separation. The voucher section 7 is non-adhesive only on its end projecting inside the turn 4f above the contour of the base layer 1, so that it may be grasped there by the user without the user contaminating his fingers with adhesive.

The adhesive-repellent layer 6 on the base layer 1 cited above is located below the voucher section 7 and thus prevents permanent connection between the voucher section 7 and the base layer 1.

FIG. 2 shows the label from FIG. 1, but with the cover sheet 5 folded out and the voucher section 7 separated out for explanation purposes, while the hanger loop 4 is located unchanged in the position already shown in FIG. 1.

The cover sheet 5 is folded back, for which purpose the user grasps the cover sheet 5 on the non-adhesive grasp tab 5d projecting past the contour of the base layer 1. At the same time, the cover sheet 5 is separated from the voucher section 7 and from the branch 4c of the hanger loop 4 by tearing the perforation 13. By folding back the cover sheet 5, a booklet 2 is exposed, which comprises two product information sheets 2a and 2b. By folding back the cover sheet 5, the adhesive-repellent layer 8 already noted is exposed, which is symbolized in FIG. 2 by crosshatching. When the cover sheet 5 is folded back, the information on the product information sheets 2a and 2b may be perceived. As shown in FIG. 2, opening the booklet 2 is possible independently from unfolding the hanger loop 4. To close the booklet 2, the cover sheet is moved back into the position shown in FIG. 1, so that the self-adhesive part 5c again comes into contact with the adhesive-repellent layer 8 on the base layer 1. The connecting force between the part 5c of the cover sheet 5 and the adhesive-repellent layer 8 is sufficient to hold the cover sheet 5 securely in the closed position and avoid automatic opening.

In order to remove the voucher section 7, it is gripped on its non-adhesive end, which projects above the contour of the base layer 1, and separated from the remaining upper label layer 3 along the perforation 15. After the self-adhesive voucher section 7 has been taken out, the adhesive-repellent layer 6 indicated in FIG. 2 by crosshatching, which was already cited above, is exposed. As FIG. 2 shows, the removal of the voucher section 7 is also independent of whether or not the hanger loop 4 has been unfolded.

The removed voucher section 7 may be separated into two parts if desired, in order to attach the information located thereon at two different locations. A perforation 16 makes the separating procedure easier.

FIG. 3 shows the label from FIG. 1, but with the cover sheet 5 folded out (as already shown in FIG. 2) and the hanger loop 4 additionally having been unfolded for explanation purposes. The voucher section 7 is in its original location, as shown in FIG. 1. To unfold the hanger loop 4, it is gripped in the region of the turn 4f, which projects above the long side 10 of the base layer 1, and pulled from there in the direction toward the diametrically opposing long side 9. At the same time, the easily removable perforation 13 (FIG. 1) is separated, so that only the hanger loop 4 is lifted up, while the voucher section 7 and the web 14 connecting the two root regions 4a and 4b remain back on the base layer 1. In FIG. 3, the unfolded hanger loop 4, which comprises the non-adhesive parts 4c, 4d, 4e, 4f, 4g and the web 14, which is solidly and permanently glued to the base layer 1 and connects the regions 4a and 4b, is shown. If the user wants to completely or partially remove the voucher section, he will proceed as described on the basis of FIG. 2. Closing the booklet is also performed as already explained in connection with the description of FIG. 2. The three procedures, specifically opening and closing the booklet 2, removing the voucher section 7, and unfolding the hanger loop 4, are obviously independent from one another and may be executed in any arbitrary sequence.

The label shown in FIGS. 1 through 3 and described above is intended for the purpose of being attached to a pharmaceutical infusion bottle (not shown). The label is attached in such a way that the two root regions 4a and 4b point toward the bottom of the infusion bottle. Frequently, the size of the label is selected in such a way that the mutual spacing of the two root regions 4a and 4b corresponds to half of the circumference of the bottle, so that the two roots lie on diametrically opposite points of the infusion bottle. The unfolded hanger loop 4 (FIG. 3) is then hung on the loop of the infusion frame, so that the infusion bottle is suspended head down, i.e., with the bottle opening downward, on the infusion bottle, ready to administer the infusion. In this case, the hanger loop 4 assumes the shape of a triangle because of the weight of the infusion bottle acting thereon. The great length of the hanger loop 4, which is anchored to the label on the roots 4a and 4b lying diametrically opposite on the bottle and therefore to the infusion bottle, makes it possible to hang the infusion bottle precisely vertically.

1. A label having a base layer (1), on which at least one product information sheet (2a, 2b) is positioned, and having an upper label layer (3), which is positioned on the base layer (1) and is shaped in such a way that it forms at least one hanger loop (4) and a cover sheet (5) covering the at least one product information sheet (2a, 2b).

2. The label according to claim 1,
wherein the upper label layer (3) is self-adhesive in at least partial regions of its side facing toward the base layer (1).

3. The label according to one of the preceding claims, wherein the base layer (1) is provided with at least one adhesive-repellent layer (6, 8) in at least parts of its side facing toward the upper label layer (3).

4. The label according to one of the preceding claims, wherein the upper label layer (3) is shaped in such a way that it forms at least one removable self-adhesive voucher section (7).

5. The label according to claim 4,
wherein the removable voucher section (7) lies in the region in which the at least one adhesive-repellent layer (6) is provided.

6. The label according to one of the preceding claims, which has two or more product information sheets (2a, 2b), which are connected to one another like a booklet (2).

7. The label according to one of the preceding claims, wherein the cover sheet (5) has a self-adhesive part (5a), via which it is permanently bonded to the base layer (1), a non-adhesive part (5b), using which it covers the at least one product information sheet (2a, 2b), and a further self-adhesive part (5c), using which it is removably adherent on a region of the base layer (1) coated with the at least one adhesive-repellent layer (8).

8. The label according to one of the preceding claims, wherein the hanger loop (4) is formed by a strip separated from the upper label layer (3), which is connected on at least two root regions (4a, 4b) to the upper label layer (3) and in this way forms a closed hanger loop (4).

9. The label according to one of the preceding claims, wherein the upper label layer (3) has a first (9) and a second long side (10) and two transverse sides (11, 12) and the two root regions (4a, 4b) are positioned on the first long side (9) and the hanger loop (4) has a first branch (4c), which runs starting from the first root region (4a) in the direction toward the second root region (4b) and passes into a first bend (4d), before reaching the second root region (4b), a second branch (4e), which runs starting from the first bend (4d) in the direction toward the second long side (10) and passes into a turn (4f) in the region of the second long side (10), and a third branch (4g), which runs from the turn (4f) to the second root region (4b) of the first long side (9).

10. The label according to one of the preceding claims, wherein the cover sheet (5) of the upper label layer (3) lies outside the closed hanger loop (4).

11. The label according to claim 9,
wherein the cover sheet (5) is positioned adjoining the first branch (4c) and the second branch (4e) of the hanger loop (4).

12. The label according to claim 9,
wherein the at least one removable voucher section (7) is positioned inside the hanger loop (4) between the second branch (4e) and third branch (4g) thereof.
